(19) United States
(12) Patent Application Publication
(10) Pub. No.: US 2009/0094115 A1
(43) Pub. Date: Apr. 9, 2009

(54) CREDIT CARD ACCOUNT INCENTIVE SYSTEM AND METHOD TO PROMOTE RESPONSIBLE MANAGEMENT OF ACCOUNTS

(76) Inventor: Michael A. Sisko, Windemere, FL (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 12/245,071

(22) Filed: Oct. 3, 2008

Related U.S. Application Data
(60) Provisional application No. 60/977,222, filed on Oct. 3, 2007.

(51) Int. Cl. G06Q 30/00

(52) U.S. Cl. 705/14

(57) ABSTRACT

The present invention relates generally to a credit card holder awards system and method. The system and method is set up to “reward” responsible management of accounts and good credit practices. Specifically, the method and system monitors customer activity at defined intervals, selects an award winner from among the qualified customers based on a predetermined criteria and provides the predetermined award to the winning customer. The predetermined criteria used in the present invention relates to payments and good credit practices in order to allow users to develop a favorable credit history.

### RELATED APPLICATIONS

The present application is related to and claims priority from U.S. Provisional Patent Application Ser. No. 60/977,222 filed on Oct. 3, 2007.

### FIELD OF THE INVENTION

The present invention relates generally to an incentive/awards program for a defined customer group. Specifically, the present invention relates to a method and system that monitors customer activity within a customer portfolio, preferably at regular intervals, to determine if predetermined criteria is met. The customers that have met the criteria are qualified to participate in an award giveaway, and the system then selects at least one award winner from among the qualified customers. The predetermined criteria is selected to provide incentives for customers to act responsibly and manage their affairs in a reasonable manner. By providing a recurring customer award program based on carefully selected criteria related to account activities, the present invention creates an incentive/awards program in a manner that generates customer enthusiasm and promotes responsible customer activity.

### BACKGROUND OF THE INVENTION

To create loyalty and entice certain activities customer award programs are implemented by many different organizations. One example of such a customer awards program exists in the credit card industry where customers obtain points for card usage. The points are then redeemable through some means for specific products or awards of cash or credit. These programs provide an incentive for customers to continue using their cards and being active members of the account portfolio.

Other awards programs in the credit card field are based on either the individual customer's annual card usage—resulting in a year-end reimbursement—or a specific purchase made with the card—resulting in a free purchase. In other industries, products or services are awarded as prizes or rewards for loyalty or continued purchases. For instance, it is common for airlines to award “miles” to its customers as a reward for flying, such that the miles are redeemable for free or discounted travel services. Similarly, retail stores may award points to members of a loyalty program for their purchases, where the points may be used for products at the store.

All of these programs are based on the customers' personal transactions; i.e., the amount “awarded” is based on each individual customer's purchases. For instance, an individual's credit card may reimburse 0.5% of his or her purchases at the end of the year through cash/credit/points. Likewise, customers receive the points or miles as described above based on each customer's individual purchase activity.

Each of the above referenced programs provide effective programs to entice customers to continue utilizing their accounts. For the typical card customer, this provides options and opportunities for them to participate in a rewards program that is appealing. Once a member of a particular card portfolio, the continued use of the card provides the account holder with the desired award, or the potential for receiving the desired award.

For certain customers these awards/incentive programs are not effective because they do not have the opportunity to participate at a necessary level. Specifically, in the “sub-prime” market, cardholders typically have very low credit limits, and have limitations on card activity within a particular time period. Often, the customers in this market have poor credit, due to some mishap, or have not yet developed a credit history. For example, students and younger people often have not had the opportunity to hold credit accounts, thus making them higher risk customers. As another example, customers may have had financial difficulties resulting in bankruptcy or some other negative event. In these situations, the typical awards/incentive programs are not practical or feasible due to the limitations placed on the account. For example, a cash-back award of 0.5% of transactions, where the cardholder is limited to $300.00/month in charges would result in a potential payback of $1.50 per month, providing that the cardholder can repay the $300/month charges at the end of each month. This level of payback is not likely to provide an incentive to most customers.

There is therefore a need for a system and method which would reward customers in a manner that creates the potential for meaningful and substantial rewards. There is also a need for a system and method for rewarding customers that use their credit card responsibly. There is also a need for a system and method for rewarding customers that occurs at frequent, regular intervals, not just annual, seasonal, or ad hoc periods. In particular, there is a need for a system and method for administration of a rewards program that generates excitement and “buzz” by offering customers regular opportunities to win award values greater than a percentage of each individual customer's transactions. There is a further need to generate a rewards program that provides incentives for responsible use and management of a credit account. The present invention is directed toward meeting these needs.

### SUMMARY OF THE INVENTION

For these reasons, one object of the present invention to provide an awards program that creates excitement, entertainment, and anticipation for customers while also providing incentives to act in a responsible manner. More specifically, a system and method is provided for rewarding customers by creating the possibility of winning significant awards, substantially greater than a percentage of each individual customer's transactions. It is a further object of the present invention to provide a system and method for rewarding customers at frequent, regular intervals, based upon the responsible actions of the customer. It is yet another goal of the present invention to provide a system and method for rewarding customers in a manner that generates enthusiasm and customer loyalty while providing incentives for the customer to act responsibly.

To meet these objectives and goals, the present invention provides a random entertaining incentive/reward program for those involved. In its most basic terms, this involves the periodic award of prizes to a defined customer group, based upon those customers meeting a defined criteria. In order to provide additional anticipation and excitement, the award itself is substantial when compared with existing account activity.

One method of practicing the present invention includes the initial step of acquiring or defining a customer group. As an example, the customer group may include the holders of a particular credit card, the holders of a retail loyalty card (clothing stores, gas stations, resorts, etc.), or members of travel groups, such as airline frequent travelers and hotel preferred customers. The process of defining the particular customer group depends on the sponsoring organization or the type of activity that is desirable for the sponsoring organization and thus worth rewarding. For instance, the sponsoring agency may be a credit card company that is issuing cards to high risk individuals, individuals who have had a “credit accident” or individuals who have not established a credit history (e.g. students and younger people). In that situation, the sponsoring agency is trying to promote good credit practices such as on-time payments and no charges over the customers credit limit. Given these goals, the account group can thus be appropriately defined.

Once the customer group is identified and defined, customer activity information for an interval of predetermined length is aggregated and stored. The customer activity information is then reviewed to determine which customers are eligible to participate in a monthly reward program. Based upon this analysis, a number of entries are given to each qualifying customer. The number of entries may be determined a number of ways, but are generally directed toward the responsible management of the customers account. For example, entries may be awarded for each on-time payment or for full payment on account. Further, the number of entries could be proportional to the amounts paid in each on-time payment. At the completion of a defined time period, a winner is selected from the eligible customers using a predetermined criteria. In one example, the award winner may be randomly selected from the group of qualified customers. Alternative selection methodology could be used, such as regional selection of multiple award winners, or any other criteria directed toward motivating the desired behavior. The reward is also defined prior to the selection of the winner and may be granted as either cash, credit, gift card, debit card or products/services. Cash and credit rewards may be presented in either a lump sum or installments at the discretion of the rewards program operator.

### BRIEF DESCRIPTION OF THE DRAWINGS

FIG. 1 is a schematic block diagram illustrating the information flow between parties according to one embodiment of the present invention;

FIG. 2 is a flow chart illustrating the steps used to implement one embodiment of the method of the present invention.

### DETAILED DESCRIPTION OF PREFERRED EMBODIMENTS

As described above, one feature of the present invention is the opportunity for customers to participate in a rewards program and potentially to receive a substantial award. Further, the opportunity is recurring, which creates continuous excitement for as long as the customers remain in good standing and involved with the program. The system and award program of the present invention is also capable of being tailored toward a specific customer base to ensure that the awards are appropriate to the targeted customer group. In addition, the rewards program provides incentives for customers to act in ways that are responsible and desirable to the sponsoring agency.

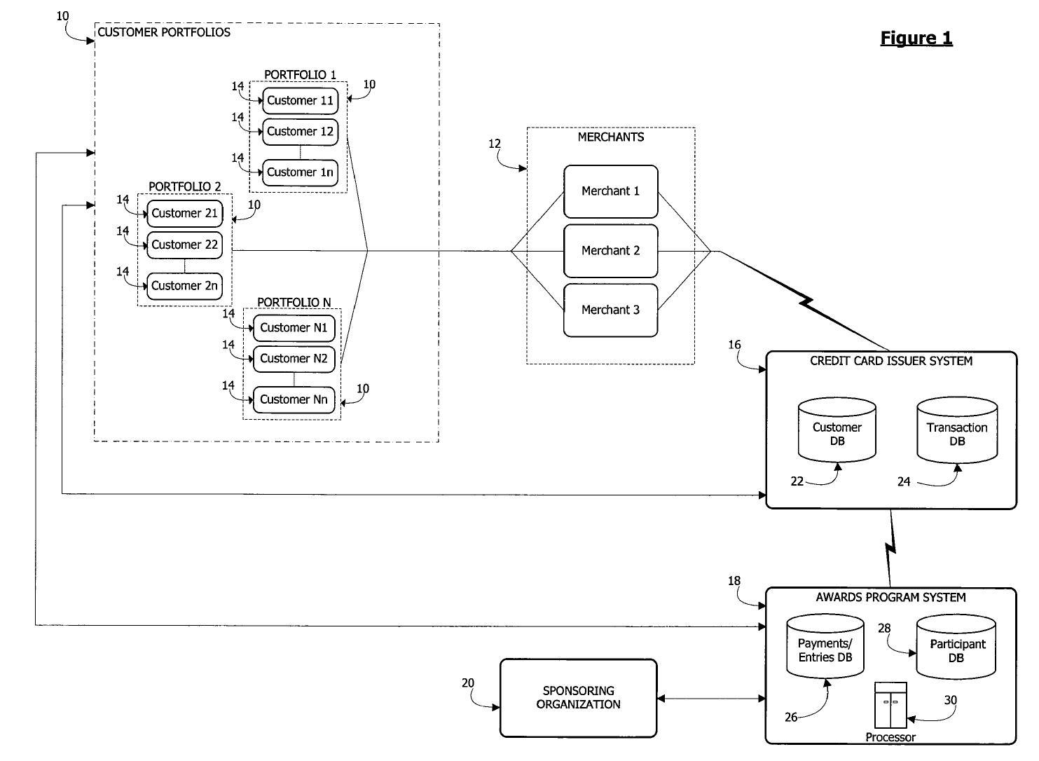

FIG. 1 illustrates the information flow between the relevant parties according to one embodiment of the present invention. A plurality of portfolios 10 each include a plurality of customers 14. Each portfolio 10 includes a group of customers with some common interest or association. In this embodiment, the customer group will likely be high-risk credit customers potentially including those who have had some type of “credit accident” (e.g. bankruptcy, foreclosures, adverse judgments, etc.) Further, young people may be included in this program as they typically have not developed a credit history.

The activities of each customer 14 are monitored and stored by an awards program system 18 as described in more detail herein. In the credit card context, the customers 14 complete transactions with a plurality of merchants 12 via common point-of-sale terminals, which collect transaction data and transmit the data to a credit card issuer system 16. The credit card issuer system 16 uses a transaction database 24 to store the transaction data and uses the transaction data to manage the customer accounts, which are stored in a credit card customer database 22. The credit card issuer system 16 also communicates with customers 14 by issuing regular statements and other communication methods. In addition, credit card issuer system 16 monitors payment and credit actively from the customer 14 as a part of the transaction data that is monitored. This payment information is also stored in credit card customer database 22 and transaction database 24.

Relevant portions of the customer information and transaction data are provided to the awards program system 18 for purposes of managing and administering the awards program. The awards program system 18 maintains account information for each customer 14 in an awards program participant database 28. The information received from the credit card issuer system 16 may include customer 14 identification information, dollar amounts charged during a predetermined period, payments during the predetermined period and customer eligibility information. This information is utilized to determine which customers are eligible to participate in the award program, based upon established criteria. Those customers who meet the criteria are awarded entries, again governed by the criteria previously established. The account information and related entry information is stored by the awards program system 18 in an entries 26 database.

Processor 30 of the awards program 18 determines an award winner from the eligible customers 14 based on a predetermined award criteria. The awards program system 18 then provides award notification and/or payment information to the appropriate customer 14. The awards program system 18 may also provide such information to the credit card issuer system 16 and sponsoring organization 20 where appropriate.

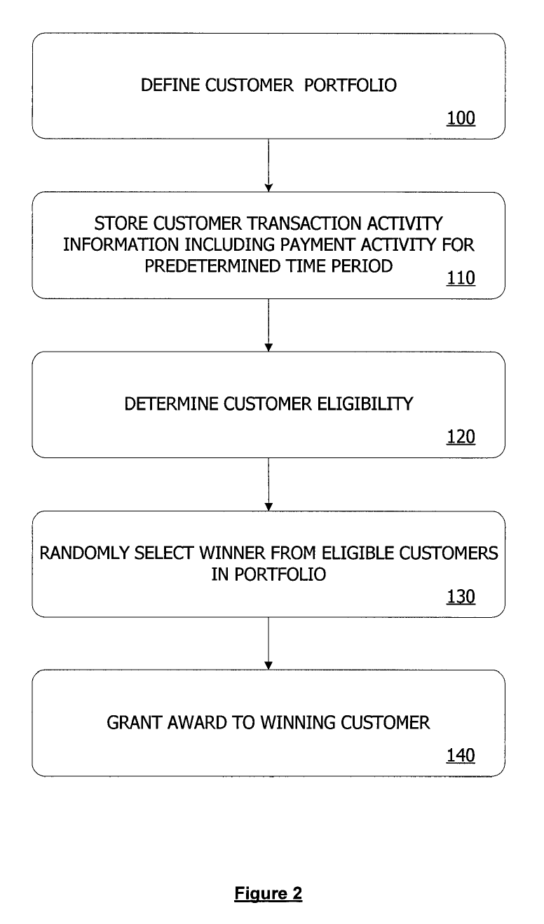

With the system architecture described above, the operation of the system is now explained. Referring now to FIG. 2, one embodiment of the present invention first defines customer portfolios, step 100. A sponsoring organization 20 may engage the awards program system 18 to administer an awards program. In conjunction with a credit card issuer system 16, such as a banking institution, the awards program system 18 offers credit cards to potential customers, who then open credit card accounts with the credit card issuer 16. The appropriate customer 14 personal information, credit information, and account information is stored in the credit card customer database 22 of the credit card issuer system 16. Because the act of opening an awards program credit card potentially makes the customer 14 an awards program participant, the awards program system 18 will also store the necessary customer 14 information in the awards program participant database 28.

The participating customers may be acquired through both traditional and non-traditional credit card acquisition channels, customer group enrollment, existing customer groups, in store sign-ups, etc. These channels may include, but are not limited to: direct mail, telemarketing, print advertisements (e.g. inserts, “take ones”), electronic advertisements (e.g., Internet, television), public relations, event marketing, call center transfer programs, branches, and agents. Additionally, targeted marketing toward predetermined groups or organizations (both existing and new) may be undertaken. As is well-known, potential customers may be rejected from an awards-program card based on a variety factors, such as bankruptcy score, risk score, demographic credit bureau information, and/or behavior screens. Given the particular features of the awards system, it is anticipated that fewer rejections will occur however, for reasons more fully outlined below.

At step 110, customer activity is tracked. Customers 14 who sign up for the awards program conduct credit card transactions with merchants 12 via common point-of-sale terminals, which collect transaction data and transmit the data to the credit card issuer system 16 during a predetermined period. The customer transaction activity information is stored in the transaction database 24 as the information is received by the credit card issuer system 16 from the merchant 12. Typically this information is transmitted electronically from the merchant 12 to the credit card issuer system 16. The credit card issuer system 16 will also track payment and credit information as these activities occur.

Once the appropriate information is received and processed by the credit card issuer system 16, a subset of that information is sent electronically from the credit card issuer system 16 to the awards program system 18. The customer activity information that is transmitted from the credit card issuer system 16 to the awards program system 18 may include a customer's 14 individual activities immediately after completion, or each customer's 14 total activity amounts for the entire predetermined period. The predetermined period may be as long or short as desired, however, it is the regularly-occurring nature of the award that creates anticipation and loyalty by participating customers, thus a regular interval is desirable. Typically, this predetermined period will be consistent with the time period used for mailing account statements to participating customers. As is appreciated by credit card users, this is typically done monthly. The customer activity information received by the awards program system 18 is stored in the customer activity/entries database 26 and, if necessary, associated with the appropriate customer information in the awards program participant database 28.

In step 120, at the conclusion of the predetermined period, the awards program system 18 determines which customers 14 are eligible to win the award based on customer standing. The customers' eligibility may depend on a variety of factors involving responsible credit behavior. For instance, the group of eligible customers may include may include all customers except those who have a negative account status, are delinquent or in default, or have had no activity for the relevant period. Similarly, the group of eligible customers may include those who have made on-time payments in the last period and may include those who have not exceeded their credit limit. Further, the group of eligible customers may include those who have received a credit line increase due to responsible credit management. For example, a customer who receives a credit line increase from $300 to $500 resulting from good credit behavior, could receive 200 additional entries as a reward for that good behavior. The sponsoring organization may establish any criteria to determine customer eligibility, and eligibility requirements are easily designed and implemented depending on the desires of the sponsoring organization.

In step 130, the processor 30 of the awards program system 18 selects a winning customer from among the eligible customers for the predetermined time period. In selecting a winning customer, several mechanisms may be implemented. For example, each eligible customer may be assigned an equal probability of being selected as the winner. Alternatively, each eligible customer may be assigned a weighted probability of being selected as the winner that is proportionally based on that customer's payment activity for the relevant period. For instance, each dollar paid, whereby payment lessens the customer's outstanding amount owed, may constitute an “entry” ($1=1 entry) such that each “entry” constitutes an opportunity to win. In that case, a customer who pays $200 during a period would have twice the probability of winning than a customer who paid $100 during that period and such an incentive to encourage payment results in good credit behavior. Alternatively, each customer may automatically receive one “entry” per period, with each dollar paid resulting in an additional entry.

In an embodiment where participating credit cards are implemented, the processor 30 determines the total number of eligible customers and identifies those customers (designated as C₁, C₂, C₃ . . . Cₙ where n=total number of eligible customers). Next, the payment activities related to the participating credit cards are monitored for each customer. The net payments (NP) are then calculated for each eligible customer by combining payments (P) and returns (R):

NP=ΣPₓ+ΣRₓ (for customer Cₓ, where Cₓ is one of the customers C₁ . . . Cₙ)

In the example where each customer is awarded an entry for each payment, the payments for customer Cₓ is typically rounded to the nearest dollar. The process of calculating Net Payment is performed for each individual customer, C₁ . . . Cₙ. Based on each calculated “Net Payments,” the customers are then assigned one entry (E) for each dollar calculated.

In order to determine the winning customer, each individual customer is assigned a set of unique entry numbers such that the total number of entry numbers assigned to a customer corresponds to the number of entries for that customer during the predetermined time period. For example, the unique entry numbers may be selected from the range: 0 . . . Total Entries-1. The winner is ultimately chosen using a standard random number generator which randomly generates a decimal number (RNDM) between zero (0) and one (1). The winning entry number is determined by:

Winning Number=INT(RNDM*Total Entries)

As shown in the equation above, the winning number will be a randomly generated integer between 0 and the number of total entries less 1. With each eligible customer having a unique set of entry numbers, the above determined winning number will be previously associated with one customer. Thus, this allows for the identification of the winning customer.

In one embodiment, the reward may be a straight cash or credit award of that is a predetermined amount. Similarly, a gift card could easily be used. In an alternative embodiment, the award may be a product or service provided to the winning customer. For instance, the customer may be awarded products such as consumer electronics or household goods, or the customer may be awarded points in a larger rewards program.

Once the winner has been selected, step 130, the award is granted to the winning customer 14, in step 140. If the award is a lump sum payment to the customer 14, the amount is dispersed to the customer via cash or credit. This amount may be provided either directly from the awards program system 18 to the winning customer 14, or, alternatively, the awards program system 18 may provide the necessary information to the sponsoring organization 20 or the credit card issuer system 16 and allow the winning amount be dispersed from the latter to the winning customer 14. Other attendant actions may accompany the step of granting the award, step 140. For instance, the winning customer or the specific award may be published via media statements.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

What is claimed is:

1. A method for incentivizing and rewarding responsible credit management, and providing a consumer incentive/rewards program for consumers participating in a credit portfolio, the method comprising:
defining an account portfolio, the account portfolio including a plurality of customers;
storing transaction information for each of the plurality of customers, wherein the transaction information for each of the plurality of customers includes purchase and payment activity;
analyzing the purchase and payment activity for each customer to determine if predetermined standards are met and identifying customers as qualified customers if the predetermined criteria is met;
randomly selecting a winning customer from a group which includes all qualified customers;
determining a predetermined award corresponding to the predetermined criteria; and
presenting the award to the winning customer.

2. The method of claim 1 wherein the award is a cash payout.

3. The method of claim 1 wherein the award is a credit to the customer's account.

4. The method of claim 1 wherein the predetermined criteria includes the customer having a positive net payment amount.

5. The method of claim 4 wherein the customer is assigned entries proportional to their net payment amount and the winning customer is selected by selecting one of the entries for all qualified consumers participating in the credit portfolio.

6. The method of claim 1 wherein the predetermined criteria includes those customers making on-time payments.

7. The method of claim 1 wherein the predetermined criteria includes those customers with account balances below their credit limit.

8. The method of claim 1 wherein the award is a product give-away.

9. The method of claim 1 wherein in the predetermined criteria includes those customers qualifying for a credit increase.

10. The method of claim 1 wherein the predetermined criteria includes payment of the customer's entire balance.

11. The method of claim 4 wherein the customer is assigned entries proportional to their net payment amount and the winning customer is selected by selecting one of the entries for all qualified consumers participating in the credit portfolio.

12. A awards method to provide incentives for good credit practices and rewarding responsible credit management by providing a consumer incentive/rewards program for consumers participating in a credit portfolio, the method comprising:
defining an account portfolio, the account portfolio including a plurality of customers who have the ability to conduct credit transactions;
storing transaction information for each of the plurality of customers, wherein the transaction information for each of the plurality of customers includes purchase and payment activity along with account balance information;
analyzing the purchase and payment activity for each customer to determine if predetermined standards are met and identifying customers as qualified customers if the predetermined criteria is met, wherein the predetermined criteria comprises making an on-time payment to the account;
assigning at least one qualified entry into a drawing for each qualified customer and correlating that entry to the qualified customer;
selecting a winning entry from a collection of entries corresponding to all qualified customers in the portfolio and identifying the customer corresponding to the winning entry;
determining a predetermined award corresponding to the predetermined criteria; and
presenting the award to the winning customer.

13. The method of claim 12 further comprising awarding additional entries to those customers satisfying additional criteria.

14. The method of claim 13 wherein the additional criteria comprises paying off the balance on the consumer's account.

15. The method of claim 13 wherein the customer is awarded one entry for each dollar amount of their on-time payment.
